(19) United States
(12) Patent Application Publication
(10) Pub. No.: US 2025/0166073 A1
(43) Pub. Date: May 22, 2025

(54) COMPANY INFORMATION ANALYSIS SYSTEM AND METHOD USING EXPECTED PEG

(71) Applicant: PEG Technologies Inc., Changwon-si, Gyeongsangnam-do (KR)

(72) Inventor: Jinki YOON, Changwon-si (KR)

(73) Assignee: PEG Technologies Inc., Changwon-si, Gyeongsangnam-do (KR)

(21) Appl. No.: 18/854,195

(22) PCT Filed: May 13, 2024
(86) PCT No.: PCT/KR2024/006513

§ 371 Date: Oct. 4, 2024

(30) Foreign Application Priority Data
Jun. 3, 2023 (KR) 10-2023-0071979

(51) Int. Cl. G06Q 40/06; G06F 17/18

(52) U.S. Cl. CPC G06Q 40/06; G06F 17/18

(57) ABSTRACT

An embodiment of the present disclosure relates to a company information analysis system and method using expected PEG, which provides a function for calculating, storing, and displaying the expected PEG based on stock price and EPS data received from an entity providing financial market data. The company information analysis system using the expected PEG according to an embodiment of the present disclosure includes: (a) a parameter setting unit; (b) a data collection unit; (c) a data arithmetic-operation unit; (d) an arithmetic-operation result storage unit; and (e) a display unit, and the company information analysis method using the expected PEG includes: (a) a parameter setting stage; (b) a data collection stage; (c) a data arithmetic-operation stage; (d) an arithmetic-operation result storage stage; and (e) a display stage.

### TECHNICAL FIELD

The present disclosure relates a company information analysis system and method using an expected PEG, which calculates the expected PEG based on company information data received from an entity providing financial market and company-related data, and provides a function for analyzing, storing, and displaying expected PEG information so that a user may quantitatively evaluate company information.

### BACKGROUND ART

Price earnings to growth ratio or price to earnings growth ratio (PEG) is an investment indicator that shows how expensive a stock is relative to the growth rate of a company. An expected PEG is calculated using the expected earnings growth rate of a company, and thus is a key element in evaluating company value. However, the PEG (including expected PEG) has various calculation methods, and the PEG calculation methods developed so far have been usable only when a company is in a surplus and its performance is increasing.

More specifically,

First, the PEG is currently being presented in various calculation methods, and the results vary depending on each calculation method, making it difficult for investors to use. In addition, the PEG is finally computed by calculating various variables multiple times for each company during the analysis, making it inconvenient for investors to use.

Second, according to the conventional expected PEG calculation method, when a company turns from a surplus to a deficit, or turns from a deficit to a surplus, or incurs a larger deficit from a deficit state, or turns from a large deficit to a small deficit, errors occur in the expected earnings per share (EPS) growth rate or the expected PEG calculation. This prevents investors from accurately assessing company value. As such, due to these issues with the conventional PEG calculation method, in practice, the expected PEG is computed and provided only when a company is in a surplus and company performance is increasing. As a result, there is an issue in that expected PEG data may not be provided continuously.

### DETAILED DESCRIPTION OF INVENTION

### Technical Problems

The present disclosure is directed to addressing an issue associated with the related art, and to providing a company information analysis system and method using an expected PEG characterized by implementing a function for quantitatively analyzing and displaying data related to the expected PEG so that investors are able to efficiently use the PEG by making it easy to calculate the expected PEG and providing a correct expected PEG value even when a company is in deficit, turns from a deficit to a surplus, or turns from a surplus to a deficit, or when company performance decreases while in surplus.

### Technical Solution

An embodiment of the present disclosure provides a company information analysis system and method in which an expected PEG value is not interrupted by implementing an algorithm that provides a correct expected PEG value even when a company is in deficit, turns from a deficit to a surplus, or turns from a surplus to a deficit, or when company performance decreases while in surplus, by receiving data necessary for company analysis from an entity providing company data.

### Effect of Invention

According to a company information analysis system and method using an expected PEG according to an embodiment of the present disclosure,

First, a user can evaluate company value by utilizing automatically arithmetic-operated expected PEG without having to collect data one by one to calculate the expected PEG.

Second, even when a company is in deficit, turns from a deficit to a surplus, or turns from a surplus to a deficit, or when company performance decreases while in surplus, it is possible to provide correct expected PEG values, and thus investors can efficiently use the expected PEG for investment.

Third, it is possible to provide continuous PEG values by resolving the issue of expected PEG discontinuity caused by expected PEG calculation errors.

Fourth, investors can quantitatively predict long-term stock prices by using the expected PEG.

Fifth, investors can easily use expected PEG data from a time-series perspective due to the provision of continuous expected PEG values.

### BRIEF DESCRIPTION OF THE DRAWING

FIG. 1 is an exemplary diagram illustrating the configuration of a data management server of a company information analysis system using an expected PEG according to the implementation of the present disclosure.

FIG. 2 is a flowchart illustrating an example of an analysis storage display process in the case of analyzing a company using the expected PEG according to the implementation of the present disclosure.

FIG. 3 is an exemplary diagram illustrating an example of implementing company analysis information, expected PEG data, and past PER data display results according to the implementation of the present disclosure.

FIG. 4 is an exemplary diagram illustrating an example of implementing company analysis information, expected PEG trailing twelve months, and PER data display results trailing twelve months according to the implementation of the present disclosure.

FIG. 5 is an exemplary diagram illustrating an example of implementing a yearly expected PEG data display result according to the implementation of the present disclosure.

FIG. 6 is an exemplary diagram illustrating an example of implementing a daily expected PEG data display result according to the implementation of the present disclosure.

FIG. 7 is an exemplary diagram illustrating an example of displaying a comparison result of the effect of the conventional expected PEG by year and the expected PEG according to an embodiment of the present disclosure according to the implementation of the present disclosure.

FIG. 8 is an exemplary diagram illustrating an example of a comparison result of the effect of the conventional daily expected PEG and the expected PEG according to an embodiment of the present disclosure according to the implementation of the present disclosure.

FIG. 9 is an exemplary diagram illustrating an example of a comparison result of the effect of the conventional expected PEG trailing twelve months by year and the expected PEG trailing twelve months according to an embodiment of the present disclosure according to the implementation of the present disclosure.

### BEST MODE FOR CARRYING OUT THE INVENTION

With reference to the attached drawings, the present disclosure is described in detail so that those skilled in the art can easily understand and reproduce the present disclosure through the described preferred embodiments.

The present disclosure may be modified in various ways and have various forms, and it should be understood that the description of the present disclosure through the embodiments is not intended to limit the present disclosure to a specific exemplary form, and includes all modifications, equivalents, and substitutes included in the spirit and technical scope of the present disclosure.

As used herein, the term “company information” refers to financial market and company-related information needed for expected PEG analysis.

As used herein, the term “data collection” refers to collecting stock prices and/or EPS data from entities providing financial and/or company performance data, such as institutions providing financial market or company-related information on a server, individual securities firms, company data providers, and foreign similar financial and/or company data providing entities.

The terms used throughout the specification of the present disclosure are defined in consideration of the functions in the embodiments of the present disclosure, and may be sufficiently modified according to the intent of users or operators or custom, so the definitions of these terms should be made based on the contents throughout the present specification.

### (1) Configuration of Data Management Server of Company Information Analysis System

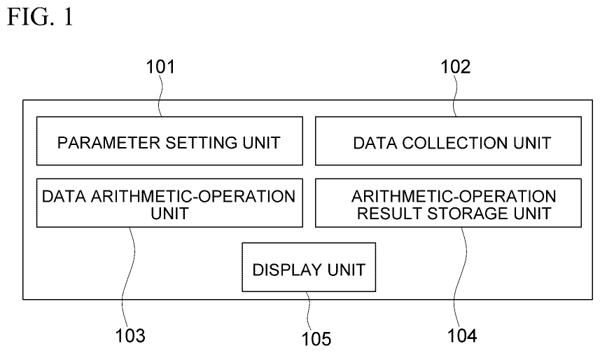

FIG. 1 is an exemplary diagram illustrating the configuration of a data management server of a company information analysis system using an expected PEG according to an embodiment of the present disclosure.

The data management server of the company information analysis system using the expected PEG includes:
(a) a parameter setting unit 101 that sets parameters necessary for analyzing a company in the server;
(b) a data collection unit 102 that collects stock prices and EPS data necessary for analyzing the expected PEG in the server;
(c) a data arithmetic-operation unit that arithmetic-operates the expected PEG using data collected in (b) and arithmetic-operation formulas in the server;
(d) an arithmetic-operation result storage unit that stores data used for analysis and expected PEG calculation results in the server; and
(e) a display unit that displays company information and the expected PEG calculation results arithmetic-operated and processed in the server on a screen.

Herein, in the arithmetic-operation unit of (c), when the expected PEG is calculated by specifically arithmetic-operating the PEG, [Mathematical Formula 13], [Mathematical Formula 14], [Mathematical Formula 15], [Mathematical Formula 16], [Mathematical Formula 17] and [Mathematical Formula 38] are used for the arithmetic operation; and when the expected PEG trailing twelve months are calculated, [Mathematical Formula 32], [Mathematical Formula 33] and [Mathematical Formula 34] are used for the arithmetic operation.

$$1 YE PEG = ABS ( P / EPS t + 1 ) / \{ EPS t + 1 - EPS t ) / ABS ( EPS t ) \times 100 \} \qquad [ Mathematical Formula 13 ]$$

where,
1YE PEG=Expected PEG in 1 year (1YE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
ABS=Absolute value

$$2 YE = ABS ( P / EPS t + 2 ) / ( EPS t + 2 - EPS t + 1 ) / ABS ( EPS t + 1 ) \times 100 \} \qquad [ Mathematical Formula 14 ]$$

where,
P=Stock price on a calculation date
2YE PEG=Expected PEG in 2 years (2YE PEG)
EPS t+1=Expected EPS in 1 year based on the last day of the previous year prior to a year in which the calculation date falls
EPS t+2=Expected EPS in 2 years based on the last day of the previous year prior to a year in which the calculation date falls
ABS=Absolute value

$$3 YE = ABS ( P / EPS t + 3 ) / \{ ( EPS t + 3 - EPS t + 2 ) / ABS ( EPS t + 2 ) \times 100 \} \qquad [ Mathematical Formula 15 ]$$

where,
3YE PEG=Expected PEG in 3 years (3YE PEG)
P=Stock price on a calculation date
EPS t+2=Expected EPS in 2 years based on the last day of the previous year prior to a year in which the calculation date falls
EPS t+3=Expected EPS in 3 years based on the last day of the previous year prior to a year in which the calculation date falls
ABS=Absolute value

$$2 YAE PEG = ABS [ P / \{ ( EPS t + 1 + EPS t + 2 ) / 2 \} ] / [ \{ EPS t + 1 + EPS t + 2 ) / 2 - EPS t \} / ABS ( EPS t ) \times 100 ] \qquad [ Mathematical Formula 16 ]$$

where,
2YAE PEG=2-year average expected PEG (2YAE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
EPS t+2=Expected EPS in 2 years based on the last day of the previous year prior to a year in which the calculation date falls
ABS=Absolute value

$$3 YAE PEG = ABS [ P / \{ ( EPS t + 1 + EPS t + 2 + EPS t + 3 ) / 3 \} ] / [ \{ ( EPS t + 1 + EPS t + 2 + EPSt + 3 ) / 3 - EPS t \} / ABS ( EPS t ) \times 100 ] \qquad [ Mathematical Formula 17 ]$$

where,
3 YAE PEG=3-year average expected PEG (3YAE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
EPS t+2=Expected EPS in 2 years based on the last day of the previous year prior to a year in which the calculation date falls
EPS t+3=Expected EPS in 3 years based on the last day of the previous year prior to a year in which the calculation date falls
ABS=Absolute value

$$1 YBDE PEG = ABS ( P / EPS t + 1 ) / \{ ( EPS t + 1 - EPS ct ) / ABS ( EPS ct ) \times 100 \} \qquad [ Mathematical Formula 18 ]$$

where,
1YBDE PEG=Expected PEG in 1 year before company performance is announced after the year has changed (1YBDE PEG)
P=Stock price on a calculation date
EPS ct=Expected EPS (consensus, estimated EPS) of the previous year (t) prior to a year in which the calculation date falls
EPS t+1=Expected EPS in 1 year based on the last day of the previous year prior to a year in which the calculation date falls
ABS=Absolute value

$$1 YE PEG ttm = ABS ( P / EPS ttm + 1 ) / \{ ( EPS ttm + 1 - EPS ttm ) / ABS ( EPS ttm ) \times 100 \qquad [ Mathematical Formula 32 ]$$

where,
1YE PEG ttm=Expected PEG trailing 12 months in 1 year (1YE PEG ttm)
P=Stock price on a calculation date
EPS ttm=EPS trailing 12 months of the previous month prior to a month in which the calculation date falls
EPS ttm+1=Expected EPS trailing 12 months in 1 year based on the previous month in which the calculation date falls
ABS=Absolute value

$$2 YE PEG ttm = A B S ( P / EPS ttm + 2 ) / \{ ( EPS ttm + 2 - EPS ttm + 1 ) / ABS ( EPS ttm + 1 ) \times 100 \} \qquad [ Mathematical Formula 33 ]$$

where,
2YE PEG ttm=Expected PEG trailing 12 months in 2 years (2YE PEG ttm)
P=Stock price on a calculation date
EPS ttm+1=Expected EPS trailing 12 months in 1 year based on the previous month in which the calculation date falls
EPS ttm+2=Expected EPS trailing 12 months in 2 years based on the previous month in which the calculation date falls
ABS=Absolute value

$$2 YAE PEG ttm = ABS [ P / \{ ( EPS ttm + 1 + EPS ttm + 2 ) / 2 \} ] / [ \{ ( EPS ttm + 1 + EPS ttm + 2 ) / 2 - EPS ttm \} / ABS ( EPS ttm ) \times 100 ] \qquad [ Mathematical Formula 34 ]$$

where,
2YAE PEG ttm=2-year average expected PEG trailing 12 months (2YAE PEG ttm)
P=Stock price on a calculation date
EPS ttm=EPS trailing 12 months of the previous month prior to a month in which the calculation date falls
EPS ttm+1=Expected EPS trailing 12 months in 1 year based on the previous month in which the calculation date falls
EPS ttm+2=Expected EPS trailing 12 months in 2 years based on the previous month in which the calculation date falls
ABS=Absolute value

### (2) Company Analysis Stage/Process Using Expected PEG

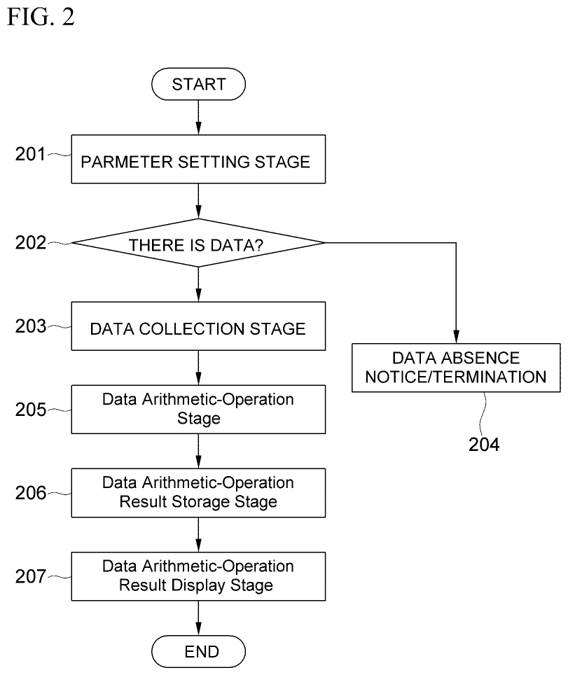

FIG. 2 is a flowchart illustrating an example of an analysis storage display process in the case of analyzing a company using the expected PEG according to an embodiment of the present disclosure.

The company information analysis server determines whether data is available in the data collection unit 102 of the server according to the parameters (202) set in a parameter setting stage (201), and proceeds to a data collection stage (203) when the data is available. The data collection unit 102 collects stock price and/or EPS data from entities providing financial information and company-related information via the Internet, such as financial and/or company information providers, securities firms, specialized company information providers, foreign financial markets and company information providing entities. The data arithmetic-operation unit 103 arithmetic-operates on the collected data using an arithmetic-operation formula in a data arithmetic-operation stage (205), stores the PEG calculation result arithmetic-operated according to the conditions set in the parameters in the arithmetic-operation result storage unit 104 in a data arithmetic-operation result storage stage (206), and shows the arithmetic-operated company information materials and expected PEG data to a user through the display unit 105 in a data arithmetic-operation result display stage (207).

When there is no data to be collected, the data collection unit 102 of the server notifies a user of a message indicating an absence of data (204) and terminates the arithmetic operation through a termination stage of data arithmetic operation (204).

In the parameter setting stage, the parameter setting unit 101 of the server is set to collect stock prices and EPS data information necessary for computing the expected PEG among various pieces of financial information and company information that may be collected from the Internet, and parameters are set regarding the conditions for arithmetic-operating and displaying the collected data according to the target period of the data analysis and the display type of the analysis result.

### (3) Examples of Expected PEG Data Arithmetic-Operation Stage

### (3-1) Example of Implementing Combination of Expected EPG and Other Pieces of Company Information

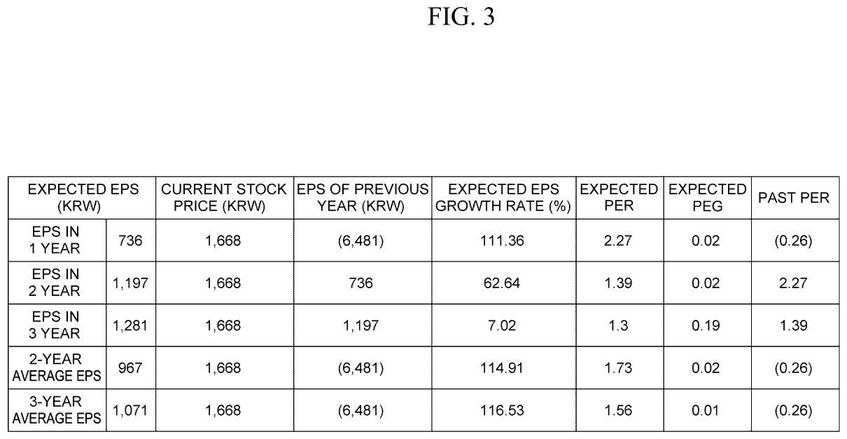

FIG. 3 is an exemplary diagram illustrating an example of implementing company analysis information, expected PEG data, and past PER data display results according to the implementation of the present disclosure.

In [FIG. 3], stock prices and EPS are assumed arbitrarily. The term “EPS in 1 year” refers to expected EPS after 1 year, the term “EPS in 2 years” refers to expected EPS after 2 years, the term “EPS in 3 years” refers to expected EPS after 3 years, the term “2-year average EPS” refers to the 2-year average expected EPS, and the term “3-year average EPS” refers to the 3-year average expected EPS. The numbers in parentheses indicate negative numbers.

In [FIG. 3], the current stock price, EPS of the previous year, EPS after 1 year, EPS after 2 years, and EPS after 3 years are data collected by the data collection unit 102 of the server, and the 2-year average expected EPS, 3-year average expected EPS, expected EPS growth rate of each expected year, expected PER, expected PEG, and past PER are data automatically arithmetic-operated and processed according to the arithmetic-operation formula in the data arithmetic-operation unit 103 of the server.

Herein, the above data are each arithmetic-operated by the following mathematical formulas.

First, the 2-year average expected EPS and 3-year average expected EPS arithmetic-operations are arithmetic-operated using the following mathematical formulas.

When the EPS of the previous year prior to a year in which the calculation date falls is EPS t, the expected EPS in 1 year from the last day of the previous year is EPS t+1, the expected EPS in 2 years is EPS t+2, and the expected EPS in 3 years is EPS t+3,

The 2-year average expected EPS (2YAE EPS) is calculated using the following formula.

$$2 YAE EPS = ( EPS t + 1 + EPS t + 2 ) / 2 \qquad [ Mathematical Formula 1 ]$$

The 3-year average expected EPS (3YAE EPS) is calculated using the following formula.

$$3 YAE EPS = ( EPS t + 1 + EPS t + 2 + EPS t + 3 ) / 3 \qquad [ Mathematical Formula 2 ]$$

The expected EPS growth rate (%) is arithmetic-operated using the following mathematical formula.

When the EPS of the previous year prior to a year in which the calculation date falls is EPS t, the expected EPS in 1 year later based on the last day of the previous year is EPS t+1, the expected EPS in 2 years is EPS t+2, and the expected EPS in 3 years is EPS t+3, and when the absolute value is expressed as ABS,
the expected EPS growth rate in 1 year (1YE EGR) is calculated using the following formula.

$$1 YE EGR = \{ ( EPS t + 1 - EPS t ) / ABS ( EPS t ) \} \times 100 ( \% ) \qquad [ Mathematical Formula 3 ]$$

The expected EPS growth rate in 2 years (2YE EGR) is calculated using the following formula.

$$2 YE EGR = \{ ( EPS t + 2 - EPS t + 1 ) / ABS ( EPS t + 1 ) \} \times 100 ( \% ) \qquad [ Mathematical Formula 4 ]$$

The expected EPS growth rate in 3 years (3YE EGR) is calculated using the following formula.

$$3 YEEGR = \{ ( EPS t + 3 - EPS t + 2 ) / ABS ( EPS t + 2 ) \} \times 100 ( \% ) \qquad [ Mathematical Formula 5 ]$$

The 2-year average expected EPS growth rate (2YAE EGR) is calculated using the following formula.

$$2 Y A E E GR = [ \{ EPS t + 1 + EPS t + 2 ) / 2 \} - EPS t ) ] / ABS ( EPS t ) \times 100 ( \% ) \qquad [ Mathematical Formula 6 ]$$

The 3-year average expected EPS growth rate (3YAE EGR) is calculated using the following formula.

$$2 Y A E E GR = [ \{ EPS t + 1 + EPS t + 2 + EPS t + 3 ) / 3 \} - EPS t ) ] / ABS ( EPS t ) \times 100 ( \% ) \qquad [ Mathematical Formula 7 ]$$

The expected PER is arithmetic-operated as follows.

When the stock price on the calculation date is P, the EPS of the previous year prior to a year in which the calculation date falls is EPS t, the expected EPS in 1 year based on the last day of the previous year is EPS t+1, the expected EPS in 2 years is EPS t+2, and the expected EPS in 3 years is EPS t+3,
the expected PER in 1 year (1E PER) is calculated using the following formula.

$$1 E PER = P / EPS t + 1 \qquad [ Mathematical Formula 8 ]$$

The expected PER in 2 years (2E PER) is calculated using the following formula.

$$2 E PER = P / EPS t + 2 \qquad [ Mathematical Formula 9 ]$$

The expected PER in 3 years (3E PER) is calculated using the following formula.

$$3 E PER = P / EPS t + 3 \qquad [ Mathematical Formula 10 ]$$

The 2-year average expected PER (2YAE PER) is calculated using the following formula.

$$2 YAE PER = P / \{ ( EPS t + 1 + EPS t + 2 ) / 2 \} \qquad [ Mathematical Formula 11 ]$$

The 3-year average expected PER (3YAE PER) is calculated using the following formula.

$$2 YAE PER = P / \{ ( EPS t + 1 + EPS t + 2 + EPS t + 3 ) / 2 \} \qquad [ Mathematical Formula 12 ]$$

The expected PEG is arithmetic-operated as follows.

When the stock price on the calculation date is P, the EPS of the previous year prior to a year in which the calculation date falls is EPS t, the expected EPS in 1 year based on the last day of the previous year is EPS t+1, the expected EPS in 2 years is EPS t+2, and the expected EPS in 3 years is EPS t+3, and when the absolute value is expressed as ABS,

The expected PEG in 1 year (1YE PEG) is calculated using the following formula.

$$1 YE PEG = ABS ( P / EPS t + 1 ) / \{ ( EPS t + 1 - EPS t ) / ABS ( EPS t ) \times 100 \} \qquad [ Mathematical Formula 13 ]$$

The expected PEG in 2 years (2YE PEG) is calculated using the following formula.

$$2 YE PEG = ABS ( P / EPS t + 2 ) / \{ ( EPS t + 2 - EPS t + 1 ) / ABS ( EPS t + 1 ) \times 100 \} \qquad [ Mathematical Formula 14 ]$$

The expected PEG in 3 years (3YE PEG) may be calculated using the following formula.

$$3 YE PEG = ABS ( P / EPS t + 3 ) / \{ ( EPS t + 3 - EPS t + 2 ) / ABS ( EPS t + 2 ) \times 100 \} \qquad [ Mathematical Formula 15 ]$$

The 2-year average expected PEG (2YAE PEG) is calculated using the following formula.

$$2 YAE PEG = ABS [ P / \{ ( EPS t + 1 + EPS t + 2 ) / 2 \} ] / [ \{ EPS t + 1 + EPS t + 2 ) / 2 - EPS t \} / ABS ( EPS t ) \times 100 ] \qquad [ Mathematical Formula 16 ]$$

The 3-year average expected PEG (3YAE PEG) is calculated using the following formula.

$$3 YAE PEG = ABS [ P / \{ ( EPS t + 1 + EPS t + 2 + EPS t + 3 ) / 3 \} ] / [ \{ EPS t + 1 + EPS t + 2 + EPS t + 3 ) / 3 - EPS t \} / ABS ( EPS t ) \times 100 ] \qquad [ Mathematical Formula 17 ]$$

The past PER is arithmetic-operated as follows.

When the stock price on the calculation date is P, the EPS of the previous year prior to a year in which the calculation date falls is EPS t, the EPS expected in 1 year based on the last day of the previous year is EPS t+1, and the expected EPS in 2 years is EPS t+2,
the past PER in 1 year (1LY PER) is calculated as follows.

$$1 LYPER = P / EPSt \qquad [ Mathematical Formula 18 ]$$

The past PER in 2 years (2LY PER) is calculated as follows.

$$2 LYPER = P / EPSt + 1 \qquad [ Mathematical Formula 19 ]$$

The past PER in 3 years (3LY PER) is calculated as follows.

$$3 LYPER = P / EPS t + 2 \qquad [ Mathematical Formula 20 ]$$

The 2-year average past PER (2YAL PER) is calculated using the following formula.

$$2 YALPER = P / EPSt \qquad [ Mathematical Formula 21 ]$$

The 3-year average past PER (3YAL PER) is calculated using the following formula.

$$3 YALPER = P / EPSt \qquad [ Mathematical Formula 22 ]$$

The arithmetic-operation results calculated using Mathematical Formulas 1 to 22 above show the expected EPS growth rate, expected PER, expected PEG, and past PER in 1 year, 2 years, 3 years, the average of next 2 years, and the average of next 3 years based on the last day of the previous year. In particular, the expected PEG shows how low the stock price (P) is compared to the expected earnings per share (EPS) growth rate of a company for the next 3 years. The PEG calculation formula used herein has the characteristic and effect of making it easy to predict a decline in the stock price by using ‘ABS (expected PER),’ unlike the conventional calculation method, so that when the future expected EPS growth rate is negative, a negative PEG value is obtained. In addition, by calculating the EPS growth rate using ‘ABS (expected EPS base value)’, the net income growth rate is correctly calculated even when a company is in deficit, so that the PEG value may be calculated without error. In addition, the expected PEG calculation method according to an embodiment of the present disclosure provides a correct expected PEG value even when the company turns from a surplus to a deficit or from a deficit to a surplus.

### (3-2) Example of Implementing Combination of Expected EPG Trailing Twelve Months and Other Pieces of Company Information

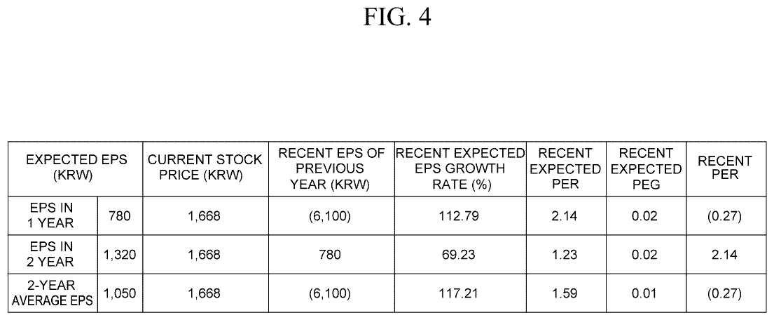

FIG. 4 is an exemplary diagram illustrating an example of implementing company analysis information, expected PEG trailing twelve months, and PER data display results trailing twelve months according to the implementation of the present disclosure.

In [FIG. 4], stock prices and EPS are assumed arbitrarily. The term “trailing” refers to the recent 12 months, the term “EPS in 1 year” refers to the recent 12-month EPS after 1 year, the term “EPS in 2 years” refers to the recent 12-month EPS after 2 years, and the term “2-year average EPS” refers to the 2-year average recent 12-month EPS. The numbers in parentheses indicate negative numbers.

When earnings per share (EPS) is calculated on a yearly basis, it is difficult to grasp the recent situation because the period is rather long in grasping the relationship between performance and stock price (P). To address this issue, the EPS trailing twelve months (EPS ttm) is used.

When the expected PEG trailing twelve months is calculated using the EPS trailing twelve months, because the expected EPS trailing twelve months is not provided separately by consensus, the issues is how to obtain the recent monthly 1-year (12-month) expected EPS. Generally, the consensus is provided on an annual basis. When the recent expected PEG is calculated on March 10 of a specific year, the EPS for the next 12 months is required, and the EPS until the end of February of the following year needs to be considered. Accordingly, the expected EPS trailing twelve months is computed and used by adding the expected EPS for 10 months from March to December of the current year and the expected EPS for 2 months until the end of February of the following year.

In general, when quarterly EPS is annualized, the EPS trailing twelve months of the previous month (M−1, when the month in which the calculation date falls is M) in which the calculation date falls of a specific year is historical data, and thus is always available. Annualizing quarterly EPS means that whenever earnings are announced, the EPS of the past four quarters, including the most recent earnings announcement quarter, is added together to calculate the EPS for the past year. When the annualized quarterly EPS is displayed monthly, the EPS is actually announced every three months, so the annualized EPS is updated to the same figure every month for three months before the next quarter's earnings are announced.

FIG. 4 implements the expected PEG trailing twelve months and PER trailing twelve months based on the EPS trailing twelve months using the above method.

When the month in which the calculation date falls is M, the EPS of the previous year prior to a year in which the calculation date falls is EPS t, the expected EPS in 1 year based on the last day of the previous year is EPS t+1, the expected EPS in 2 years is EPS t+2, and the expected EPS in 3 years is EPS t+3,
the expected EPS trailing twelve months in 1 year (EPS ttm+1) is calculated using the following formula.

$$EPSttm + 1 = EPSt + 1 \times \{ ( 12 - M + 1 ) / 12 \} + EPSt + 2 \times \{ ( M - 1 ) / 12 \} \qquad [ Mathematical Formula 23 ]$$

The expected EPS trailing twelve months in 2 years (EPS ttm+2) is calculated using the following formula.

$$EPSttm + 2 = EPSt + 2 \times \{ ( 12 - M + 1 ) / 12 \} + EPSt + 3 \times \{ ( M - 1 ) / 12 \} \qquad [ Mathematical Formula 24 ]$$

The expected EPS trailing twelve months in 3 years is not calculated assuming that the EPS in 4 years has not been announced.

The 2-year average expected EPS trailing twelve months is calculated using the following mathematical formula.

When the month in which the calculation date falls is M, and the EPS trailing twelve months of the previous month in which the calculation date falls is EPS ttm, the expected EPS trailing twelve months 1 year from the previous month in which the calculation date falls is EPS ttm+1, and the expected EPS trailing twelve months in 2 years is EPS ttm+2,
the 2-year average expected EPS trailing twelve months (2YAE EPS ttm) is calculated as follows.

$$2 YAEEPSttm = ( EPSttm + 1 + EPSttm + 2 ) / 2 \qquad [ Mathematical Formula 25 ]$$

Herein, the expected EPS trailing twelve month in 1 year, in other words, EPS ttm+1, is arithmetic-operated using the results calculated using [Mathematical Formula 23] above, and the expected EPS trailing twelve months in 2 years, in other words, EPS ttm+2, is arithmetic-operated using the results calculated using [Mathematical Formula 24] above.

The 3-year average expected EPS trailing twelve month is not calculated assuming that the EPS consensus in 4 years has not been announced.

The expected EPS growth rate (%) trailing twelve months is arithmetic-operated using the following mathematical formula.

When the month in which the calculation date falls is M, and the EPS trailing twelve months of the previous month in which the calculation date falls is EPS ttm, the expected EPS trailing twelve months in 1 year from the previous month in which the calculation date falls is EPS ttm+1, and the expected EPS trailing twelve months in 2 years is EPS ttm+2, and when the absolute value is expressed as ABS,
the expected EPS growth rate trailing twelve month in 1 year (1YE EGR ttm) is calculated using the following formula.

$$IYEEGRttm = \{ ( EPSttm + 1 - EPSttm ) / ABS ( EPSttm ) \} \times 100 ( \% ) \qquad [ Mathematical Formula 26 ]$$

Herein, the expected EPS trailing twelve months in 1 year, in other words, EPS ttm+1, is calculated using [Mathematical Formula 23] above, and the EPS trailing twelve months, in other words, EPS ttm, is historical data, and thus is always available.

The expected EPS growth rate trailing twelve months in 2 years (2YE EGR ttm) is calculated using the following formula.

$$2 YEEGRttm = \{ ( EPSttm + 2 - EPSttm + 1 ) / \qquad [ Mathematical Formula 27 ]$$

$$ABS ( EPSttm + 1 ) \} \times 100 ( \% )$$

Herein, the expected EPS trailing twelve months in 2 years, in other words, EPS ttm+2, is calculated using [Mathematical Formula 24], and the expected EPS in twelve months in 1 year, in other words, EPS ttm+1, is calculated using [Mathematical Formula 23].

The expected EPS growth rate trailing twelve months in 3 years is not calculated assuming that the EPS consensus in 4 years has not been announced.

The 2-year average expected EPS growth rate trailing twelve months (2YAE EGR ttm) is calculated using the following formula.

$$2 YAEEGRttm = \qquad [ Mathematical Formula 28 ]$$

$$[ \{ ( EPSttm + 1 + EPSttm + 2 ) / 2 \} - EPSttm ) ] / ABS ( EPSttm ) \times 100 ( \% )$$

Herein, the expected EPS trailing twelve months in 1 year, in other words, EPS ttm+1, is calculated using [Mathematical Formula 23] above, and the expected EPS trailing twelve months in 2 years, in other words, EPS ttm+2, is calculated using [Mathematical Formula 24] above. The EPS trailing twelve months, in other words, EPS ttm, is historical data, and thus is always available.

The 3-year average expected EPS growth rate trailing twelve months is not calculated assuming that the EPS consensus in 4 years has not been announced.

The expected PER trailing twelve months is calculated as follows.

When the stock price on the calculation date is P, the most recent EPS of the previous month prior to a year in which the calculation date falls is EPS ttm, the most recent expected EPS in 1 year based on the previous month in which the calculation date falls is EPS ttm+1, and the most recent expected EPS in 2 years is EPS ttm+2,

the expected PER trailing twelve months in 1 year (1E PER ttm) is calculated using the following formula.

$$1 EPERttm = P / EPSttm + 1 \qquad [ Mathematical Formula 29 ]$$

Herein, the expected EPS trailing twelve months in 1 year, in other words, EPS ttm+1, is calculated using [Mathematical Formula 23].

The expected PER trailing twelve months in 2 years (2E PER) is calculated using the following formula.

$$2 EPERttm = P / EPSttm + 2 \qquad [ Mathematical Formula 30 ]$$

Herein, the expected EPS trailing twelve months in 2 years, in other words, EPS ttm+2, is calculated using [Mathematical Formula 24].

The 2-year average expected PER in twelve months (2YAE PER) is calculated using the following formula.

$$2 YAEPERttm = P / \{ ( EPSttm + 1 + EPSttm + 2 ) / 2 \} \qquad [ Mathematical Formula 31 ]$$

Herein, the expected EPS trailing twelve months in 1 year, in other words, EPS ttm+1, is calculated using [Mathematical Formula 23], and the expected EPS trailing twelve months in 2 years, in other words, EPS ttm+2, is calculated using [Mathematical Formula 24].

The expected PEG trailing twelve months is calculated as follows.

When the stock price on the calculation date is P, the EPS trailing twelve months of the previous month prior to a month in which the calculation date falls is EPS ttm, the expected EPS trailing twelve months in 1 year based on the previous month in which the calculation date falls is EPS ttm+1, and the expected EPS trailing twelve months in 2 years is EPS ttm+2, and when the absolute value is expressed as ABS,
the expected PEG trailing twelve months 1 year (1YE PEG ttm) may be calculated using the following formula.

$$1 YEPEGttm = ABS ( P / EPSttm + 1 ) / \{ ( EPSttm + 1 - EPSttm ) / ABS ( EPSttm ) \times 100 \} \qquad [ Mathematical Formula 32 ]$$

Herein, the expected EPS trailing twelve months in 1 year, in other words, EPS ttm+1, is calculated using [Mathematical Formula 23], and the EPS trailing twelve months, in other words, EPS ttm, is historical data, and thus is always available.

The expected PEG trailing twelve months in 2 years (2YE PEG ttm) may be calculated using the following formula.

$$2 YEPEGttm = ABS ( P / EPSttm + 2 ) / \qquad [ Mathematical Formula 33 ]$$

$$\{ ( EPSttm + 2 - EPSttm + 1 ) / ABS ( EPSttm + 1 ) \times 100 \}$$

Herein, the expected EPS trailing twelve months in 1 year, in other words, EPS ttm+1, is calculated using [Mathematical Formula 23], and the expected EPS trailing twelve months in 2 years, in other words, EPS ttm+2, is calculated using [Mathematical Formula 24].

The 2-year average expected PEG trailing twelve months (2YAE PEG ttm) may be calculated using the following formula.

$$2 YAEPEGttm = \qquad [ Mathematical Formula 34 ]$$

$$ABS [ P / \{ ( EPSttm + 1 + EPSttm + 2 ) / 2 \} ] /$$

$$[ \{ ( EPSttm + 1 + EPSttm + 2 ) / 2 - EPSttm \} / ABS ( EPSttm ) \times 100 ]$$

Herein, the expected EPS trailing 12 months in 1 year, in other words, EPS ttm+1, is calculated using [Mathematical Formula 23] above, and the expected EPS trailing twelve months in 2 years, in other words, EPS ttm+2, is calculated using [Mathematical Formula 24] above. The EPS trailing twelve months, in other words, EPS ttm, is historical data, and thus is always available.

The recent PER is calculated as follows.

When the stock price on the calculation date is P, the EPS trailing twelve months of the previous month prior to a month in which the calculation date falls is EPS ttm, and the most recent expected EPS in 1 year based on the previous month in which the calculation date falls is EPS ttm+1,

The PER trailing twelve months in 1 year (1AT PER) is calculated as follows.

$$1 AT PER = P / EPS ttm \qquad [ Mathematical Formula 35 ]$$

Herein, the EPS trailing twelve months, in other words, EPS ttm, is historical data, and thus is always available.

The PER trailing twelve months in 2 years (2AT PER) is calculated as follows.

$$2 AT PER = P / EPS ttm + 1 \qquad [ Mathematical Formula 36 ]$$

Herein, the expected EPS trailing twelve months in 1 year, in other words, EPS ttm+1, is calculated using [Mathematical Formula 23].

The 2-year average PER trailing twelve months (2YAT PER) may be calculated using the following formula.

$$2 YA T PER = P / EPSttm \qquad [ Mathematical Formula 37 ]$$

The EPS trailing twelve months, in other words, EPS ttm, is historical data, and thus is always available.

The arithmetic-operation results calculated using Mathematical Formulas 23 to 37 above show the 2-year average expected EPS growth rate trailing twelve months, expected PER trailing twelve months, expected PEG trailing twelve months, and PER trailing twelve months in 1 year and 2 years based on the previous month prior to a month in which the calculation date falls. In particular, the expected PEG trailing twelve months shows how low the stock price (P) is compared to the expected earnings per share (EPS) growth rate trailing twelve months of a company for the next 2 years. The calculation formula of the expected PEG trailing twelve months used herein has the characteristic and effect of making it easy to predict a decline in the stock price by using ‘ABS (expected PER),’ unlike the conventional calculation method, so that when the future expected EPS growth rate trailing twelve months is negative, a negative PEG value is obtained. In addition, by calculating the EPS growth rate trailing twelve months using ‘ABS (expected EPS base value)’, the EPS growth rate trailing twelve months is correctly calculated even when a company is in deficit, so that the PEG value may be calculated without error. In addition, the calculation method of the expected PEG trailing twelve months according to an embodiment of the present disclosure provides a correct expected PEG value even when the company turns from a surplus to a deficit or from a deficit to a surplus.

### (3-3) Example of Implementing Yearly Expected PEG Data

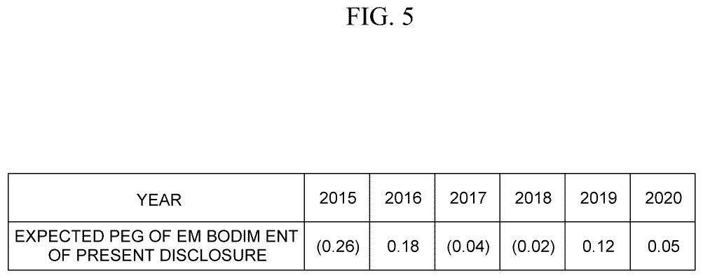

FIG. 5 is an exemplary diagram illustrating an example of implementing a yearly expected PEG data display result according to the implementation of the present disclosure.

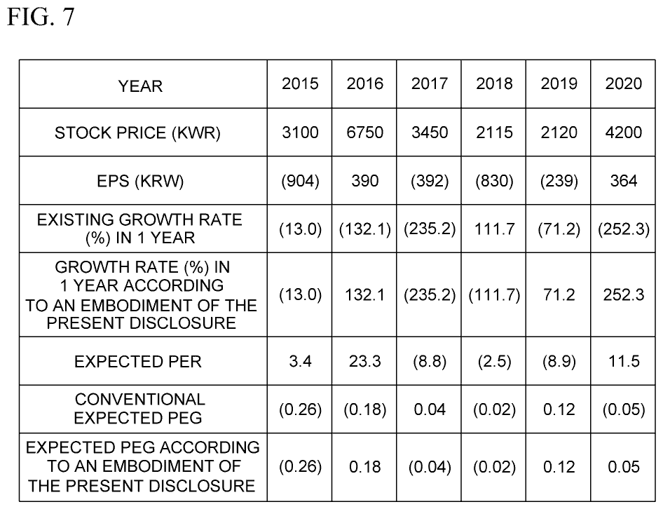

In [FIG. 5], stock prices and EPS are arbitrarily assumed when the expected PEG is calculated. It is assumed that the stock price represents the closing price at the last day of the corresponding year, and EPS represents the actual EPS of the corresponding year. The yearly expected PEG data is calculated based on the expected PEG calculation [Mathematical Formula 13] according to an embodiment of the present disclosure (see [FIG. 7] for details). In this connection, the expected PEG in 1 year refers to the expected PEG after one year calculated from the last day of the previous year prior to a year in which the calculation date, the last day of the corresponding year, falls. The numbers in parentheses indicate negative numbers. Depending on the embodiment, the expected PEG may be displayed independently of the year, only as expected PEG data.

When the closing price at the end of the year is P, the EPS of the previous year prior to a year in which the stock market closing date of the current year falls is EPS t, and the expected EPS in 1 year based on the last day of the previous year prior to a year in which the calculation date falls is EPS t+1, the expected PEG of the year in which the calculation date falls may be calculated using [Mathematical Formula 13] above. The expected PEG of the next year may be calculated in the same way. When the expected PEG of each year is obtained in the same way and time-serialized by year, the expected PEG calculation result for each year may be implemented. This is a case in which the performance data of a company is announced and an embodiment of the present disclosure is used to compute the expected PEG data for each year.

There is no difficulty in calculating the expected PEG using past stock prices and EPS from past time series financial data because there is actual performance data for all companies. However, when the expected PEG is calculated using the consensus of the expected performance of a company, there is a difference from calculating the expected PEG using past actual performance data. The timing of each company's performance announcement is different for each company. The expected PEG value on a day in the same year may be different before and after the announcement of the company performance. This is because the previous year's performance is not finalized before the announcement of the company performance even when the year changes, so there is only the estimated EPS (consensus) of the previous year (t), and there is no actual EPS of the previous year (t). This difference is reflected in the calculation result of the expected PEG.

When the stock price on the calculation date is P, the actual EPS of the previous year (t) prior to a year in which the calculation date falls is EPS t, the estimated EPS (consensus) of the previous year (t) prior to a year in which the calculation date falls is EPS ct, and the expected EPS in 1 year based on the last day of the previous year prior to a year in which the calculation date falls is EPS t+1,
the expected PEG in 1 year according to an embodiment of the present disclosure is calculated using [Mathematical Formula 13] above,

$$1 YEPEG = ABS ( P / EPS t + 1 ) / \{ ( EPS t + 1 - EPS t ) / ABS ( EPS t ) \times 100 \} .$$

When the previous year's net income per share EPS t is finalized, this mathematical formula may be used for calculation. However, when the EPS t is not finalized, the finalized previous year's EPS t is not available even when the year changes, and there is only the estimated EPS (consensus) of the previous year (t). Accordingly, in order to calculate the expected PEG, the estimated EPS (consensus) of the previous year (t), EPS ct, and the expected EPS t+1 (consensus, estimated EPS) in 1 year based on the last day of the previous year are used to calculate the expected PEG.

Accordingly, before the company performance is announced after the year changes, the expected PEG in 1 year (1YBDE PEG) may be calculated using the following formula.

$$1 YBDE PEG = ABS ( P / EPS t + 1 ) / \{ ( EPS t + 1 - EPS ct ) / ABS ( EPS ct ) \times 100 \} \qquad [ Mathematical Formula 38 ]$$

Herein, EPS ct=consensus, estimated EPS

Since the calculation methods are different as above, even in the same year, the expected PEG will be different when the previous year's performance is not announced and when the company performance is announced.

In addition, after the company's performance announcement date, the EPS ct used in the calculation is replaced with the actual finalized EPS t, so all the expected PEGs calculated before the company's performance announcement are replaced with the expected PEG calculated with the actual EPS t and EPS t+1. In addition, the overall expected EPS for the corresponding year is displayed as the result calculated using [Mathematical Formula 13] above. The data conversion of this expected PEG is repeated every year to form annual time series expected PEG data.

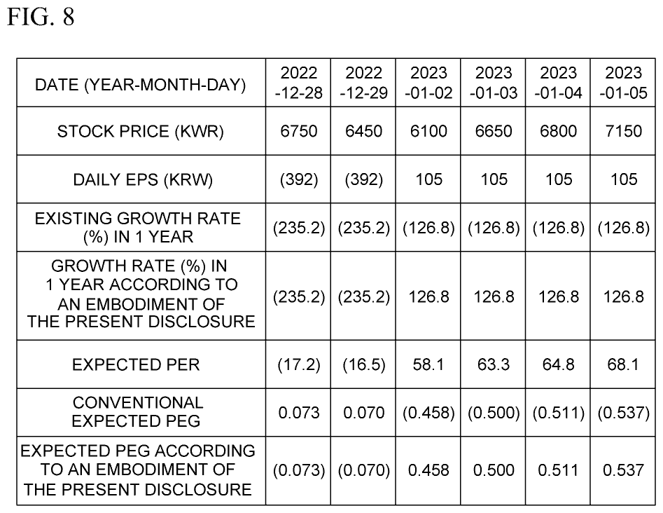

The result of displaying the expected PEG data per year according to the implementation of the present disclosure is significantly different from the result of displaying the PEG data per year calculated by the conventional method, as shown in [FIG. 8].

### (3-4) Example of Implementing Daily Expected PEG Data

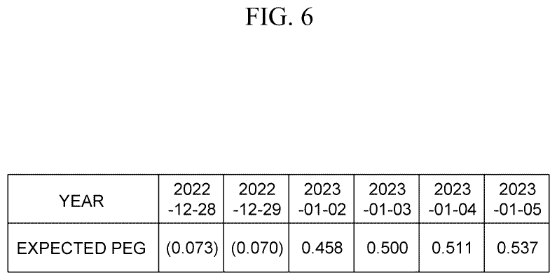

FIG. 6 is an exemplary diagram illustrating an example of implementing a daily expected PEG data display result according to the implementation of the present disclosure.

In [FIG. 6], the expected PEG is calculated by assuming that the stock prices and EPS are arbitrarily assumed. The expected PEG was calculated assuming that a company will turn from a surplus in 2021 to a deficit in 2022 until Dec. 29, 2022 (the closing date of the stock market), and that the expected EPS at the end of 2022 will be a deficit, and also that from Jan. 2, 2023 (the opening date of the stock market), the estimated EPS at the end of 2022 will turn from a deficit to a surplus at the end of 2023. (For specific details, see [FIG. 8].) Accordingly, the expected PEG for 2022 is negative, and the expected PEG for 2023 is positive. The daily expected PEG data until Dec. 29, 2022 is calculated based on the expected PEG calculation [Mathematical Formula 13] according to an embodiment of the present disclosure. In addition, the daily expected PEG data after Jan. 2, 2023 is calculated based on the expected PEG calculation [Mathematical Formula 38] according to an embodiment of the present disclosure. The numbers in parentheses indicate negative numbers.

When the stock price of the day in which the calculation date falls is P, the EPS of the previous year prior to a year in which the day falls is EPS t, and the expected EPS in 1 year based on the last day of the previous year is EPS t+1, the expected PEG of that day may be calculated using [Mathematical Formula 13] above. The expected PEG of the next day may be calculated in the same way. However, even when the daily expected PEG is calculated, the expected PEG for that day is calculated using [Mathematical Formula 38] above from the beginning of the year to which the calculation date falls until the announcement of company performance.

In this connection, when the EPS is calculated on an annual basis, the expected EPS and the expected EPS growth rate are applied equally thereafter for one year. Accordingly, in the above example, the daily expected PEG changes only by the daily stock price (P).

In this way, the expected PEG may be calculated on a daily basis for all dates for which data is available. This is used when an attempt is made to produce daily expected PEG data using an embodiment of the present disclosure.

When the company performance is disclosed, the expected PEG after the performance disclosure date will be calculated using the finalized actual EPS t and the expected EPS t+1 for 2023 instead of the estimated EPS for 2022, EPS ct, and the expected PEG calculated before the company performance disclosure is also replaced with the expected EPS calculated using the actual EPS t for 2022 and the expected EPS t+1 for 2023. [FIG. 6] is an example in which the results specifically arithmetic-operated in [FIG. 8] are implemented as individual daily expected PEG data.

The daily expected PEG data display result according to the implementation of the present disclosure is significantly different from the daily expected PEG data display result calculated by the conventional method, as shown in [FIG. 8]. Depending on the embodiment, the expected PEG may be displayed independently of the date (year-month-day), only with the expected PEG data displayed.

### (4) Comparison of Effect of Conventional Expected PEG and Expected PEG According to Embodiment of Present Disclosure

### (4-1) Comparison of Effect of Conventional Expected PEG and Expected PEG According to Embodiment of Present Disclosure by Year.

FIG. 7 is an exemplary diagram illustrating an example of displaying a comparison result of the effect of the conventional expected PEG by year and the expected PEG according to an embodiment of the present disclosure according to the implementation of the present disclosure.

In [FIG. 7], the stock prices and EPS are arbitrarily assumed values. The stock price is assumed to represent the closing price at the last day of the corresponding year, and the EPS is assumed to represent the actual EPS for the corresponding year. The expected PEG data by year is calculated based on the expected PEG calculation [Mathematical Formula 13] according to an embodiment of the present disclosure. In this connection, the expected EPS growth rate in 1 year refers to the growth rate between the EPS of the previous year prior to a year in which the calculation date, which is the last day of the year, falls and the EPS of the corresponding year. In addition, the expected PEG in 1 year refers to the expected PEG in 1 year calculated from the last day of the previous year prior to a year to which the calculation date, which is the last day of the corresponding year, falls. The EPS of 2014 was assumed to be 730 KRW, and the EPS growth rate of 2015 was calculated. The term “existing growth rate (%) in 1 year” refers to the expected EPS growth rate (%) after 1 year according to the conventional calculation method, The term “growth rate (%) in 1 year according to an embodiment of the present disclosure” refers to the expected EPS growth rate (%) after 1 year according to an embodiment of the present disclosure, the term “expected PER” refers to the expected PER after 1 year, the term “conventional expected PEG” refers to the expected PEG after 1 year according to the conventional calculation method, and the term “expected PEG according to an embodiment of the present disclosure” refers to the expected PEG after 1 year according to an embodiment of the present disclosure. The numbers in parentheses indicate negative numbers.

The conventional expected PEG is calculated using the formula “Expected PEG=Expected PER/Expected EPS Growth Rate.”

To explain this more specifically,

When the stock price on the calculation date is P, the EPS of the previous year prior to a year in which the calculation date falls is EPS t, and the expected EPS in 1 year based on the last day of the previous year prior to a year in which the calculation date falls is EPS t+1, the conventional expected PEG in 1 year (1YE PEG) may be calculated using the following formula.

$$1 YE PEG = ( P / EPS t + 1 ) / \{ ( EPS t + 1 - EPS t ) / EPS t \times 100 \}$$

On the other hand, the expected PEG in 1 year according to an embodiment of the present disclosure may be calculated using the following formula using [Mathematical Formula 13] above.

$$1 YE PEG = ABS ( P / EPS t + 1 ) / ( EPS t + 1 - EPS t ) / ABS ( EPS t ) \times 100 \}$$

As shown above, the calculation methods of the two expected PEGs are different from each other, and as a result, the expected PEG value, which is the calculation result, also differs. When the conventional expected PEG and the expected PEG effect according to an embodiment of the present disclosure are compared by year and displayed, the results are the same as shown in [FIG. 7].

When the conventional expected PEG and the expected PEG effect according to an embodiment of the present disclosure are compared based on [FIG. 7],
first, according to the conventional expected PEG calculation method, in the 2016 data, when a company turned from a deficit to a surplus, in other words, when the company turned from a deficit (EPS-904 KRW) in the previous year (2015) to a surplus (EPS 290 KRW) in 1 year (one year after the last day of the previous year), the EPS growth rate is computed as a negative number (−132.1%) even when the EPS increased from a deficit to a surplus last year (2016). The EPS actually increased because of a surplus, but the EPS growth rate being negative is a significant error (Year 2016), and the expected PEG (−0.18) calculated based thereon also has an error (Year 2016). As a result, investors may not accurately determine the company value.

According to the expected PEG calculation method according to an embodiment of the present disclosure, the EPS growth rate (132.1%) reflects the situation of turning to a surplus, and the expected PEG value is also derived as a positive number (0.18), so both are calculated correctly.

Second, according to the conventional expected PEG calculation method, in the 2017 data, when a company turned from a surplus (EPS 290 KRW) (Year 2016) to a deficit (EPS-392 KRW) one year later (Year 2017), the EPS growth rate is computed as a negative number (−235.2%), so it is calculated correctly, but the expected PER becomes a negative number (−8.8), so the expected PEG (0.04) calculated based thereon is also incorrect (Year 2017). Even though the company has turned into a deficit, the positive expected PEG is derived and does not match the facts. This prevents investors from accurately assessing the company value.

According to the expected PEG calculation method according to an embodiment of the present disclosure, the EPS growth rate is a negative number (−235.2%), reflecting the deficit conversion situation, and the expected PEG value is also computed as a negative number (−0.04), so both are calculated correctly.

In particular, according to the expected PEG calculation method according to an embodiment of the present disclosure, the expected PEG for 2017 is −0.04, which is a negative number. When the expected EPS growth rate in 1 year based on the last day of the previous year is −235.2% and the expected PER is −8.8, it indicates a tendency for EPS to decrease compared to the previous year. This improves that in general mathematical formulas, when both the numerator and denominator are negative, the calculated value becomes positive, so that the calculation result is displayed differently from the actual result. In this respect, there is a very significant difference between the effect of the conventional PEG display and the PEG display according to an embodiment of the present disclosure.

Third, according to the conventional expected PEG calculation method, in the 2018 data, a company went from a deficit (EPS-392 KRW) (Year 2017) to a larger deficit (EPS-830 KRW) in the following year (Year 2018), so that the EPS changed from a small deficit to a large deficit and the deficit increased, but the EPS growth rate is calculated as a positive number (111.7%). It is a significant error that the EPS growth rate is computed as a positive number when the EPS actually decreased (Year 2018).

According to the expected PEG calculation method according to an embodiment of the present disclosure, the EPS growth rate is correctly calculated as a negative number (−111.7%).

Fourth, according to the conventional expected PEG calculation method, in the 2019 data, the company was in deficit (EPS-830 KRW) (Year 2018), but the deficit continued in the following year (Year 2019), but the performance improved (EPS-239 KRW) and the EPS changed from a large deficit to a small deficit, so that the EPS actually increased, but the EPS growth rate is calculated as a negative number (−71.2%). Even though the company performance increased compared to the previous year and the EPS increased, the EPS growth rate was calculated as a negative number (−71.2%), which caused an error (Year 2018).

According to the expected PEG calculation method according to an embodiment of the present disclosure, the EPS growth rate was computed as a positive number (71.2%), so it was calculated correctly.

Fifth, according to the conventional expected PEG calculation method, in the 2020 data, when a company is in deficit and the EPS is negative (EPS-239 KRW) (Year 2019), an error occurs in which the EPS growth rate is calculated as negative (−252.3%) even if the company makes a profit (EPS 364 KRW) the following year 2020 (Year 2019), and the PEG value (−0.05) calculated based thereon also has an error (Year 2020). This causes an issue in that investors may not accurately determine the company value.

According to the expected PEG calculation method according to an embodiment of the present disclosure, the EPS growth rate is calculated as positive (252.3%) and the expected PEG value is calculated as positive (0.05), so both are calculated correctly.

As above, due to these issues with the conventional expected PEG calculation method, in practice, the expected PEG is calculated and provided only when a company is at a surplus and its performance is increasing. As a result, there is an issue that investors using the expected PEG lose investment opportunities because the expected PEG of a company whose company performance turns from deficit to surplus is not provided.

According to an embodiment of the present disclosure, since the aforementioned expected PEG calculation error may be resolved and the correct expected PEG value may be computed, when there is stock price data and EPS data, the expected PEG for each year may be computed at any time to generate yearly time series data and may be utilized for investment. In addition, since stock prices mostly fluctuate daily, it is also possible to compute daily PEG. Accordingly, daily PEG time series data may be generated and utilized for investment.

### (4-2) Comparison of Effect of Conventional Expected PEG and Expected PEG According to Embodiment of Present Disclosure by Day.

FIG. 8 is an exemplary diagram illustrating an example of a comparison result of the effect of the conventional daily expected PEG and the expected PEG according to an embodiment of the present disclosure according to the implementation of the present disclosure.

[In FIG. 8], the expected PEG was calculated assuming a random stock price, and assuming that a company will turn from a surplus in 2021 to a deficit in 2022 by Dec. 29, 2022 (the closing date of the stock market), and that the estimated EPS at the end of 2022 will be a deficit, and assuming that starting from Jan. 2, 2023 (the opening date of the stock market), the estimated EPS at the end of 2022 will turn from a deficit to a surplus at the end of 2023. Specifically, the daily expected PEG was calculated assuming that the EPS in 2021 is 290 KRW, the expected EPS in 2022 (EPS ct) is −392 KRW, and the expected EPS in 2023 (EPS t+1) is 105 KRW. The term “existing growth rate (%) in 1 year” refers to the expected EPS growth rate (%) after 1 year according to the conventional calculation method, The term “growth rate (%) in 1 year according to an embodiment of the present disclosure” refers to the expected EPS growth rate (%) after 1 year according to an embodiment of the present disclosure, the term “expected PER” refers to the expected PER after 1 year, the term “conventional expected PEG” refers to the expected PEG after 1 year according to the conventional calculation method, and the term “expected PEG according to an embodiment of the present disclosure” refers to the expected PEG after 1 year according to an embodiment of the present disclosure. The numbers in parentheses indicate negative numbers.

The conventional expected PEG is calculated using the formula “Expected PEG=Expected PER/Expected EPS Growth Rate.” To explain this more specifically,

When the stock price on the calculation date is P, the actual EPS of the previous year (t) prior to a year in which the calculation date falls is EPS t, the estimated (consensus) EPS of the previous year (t) prior to a year in which the calculation date falls is EPS ct, and the expected EPS in 1 year based on the last day of the previous year prior to a year in which the calculation date falls is EPS t+1,
the expected PEG in 1 year (1 YE PEG) by the conventional method may be calculated using the following formula.

$$1 YE PEG = ( P / EPS t + 1 ) / \{ ( EPS t + 1 - EPS t ) / EPS t \times 100 \}$$

The expected PEG in 1 year according to an embodiment of the present disclosure may be calculated using [Mathematical Formula 13] above.

$$1 YE PEG = ABS ( P / EPS t + 1 ) / ( EPS t + 1 - EPS t ) / ABS ( EPS t ) \times 100 \}$$

Herein, EPS t+1 is the estimated EPS in 1 year based on the last day of the previous year prior to a year in which the calculation date falls provided as the original consensus.

When the company performance is announced and the previous year's net income per share EPS tis finalized, the calculation may be done using this mathematical formula, but when the company performance is not announced yet after the year has changed, the expected PEG in 1 year (1YBDE PEG) may be calculated using the following formula.

$$1 YBDE PEG = ABS ( P / EPS t + 1 ) / \{ ( EPS t + 1 - EPS ct ) / ABS ( EPS ct ) \times 100 \} \qquad [ Mathematical Formula 38 ]$$

where, EPS ct=consensus, estimated EPS

The daily expected PEG data until Dec. 29, 2022 is calculated based on the expected PEG calculation using [Mathematical Formula 13] according to an embodiment of the present disclosure. In addition, the daily expected PEG data after Jan. 2, 2023 is calculated based on the expected PEG calculation using [Mathematical Formula 38] according to an embodiment of the present disclosure.

In the calculation of the expected EPS growth rate,

Assuming that the EPS in 2021 is 290 KRW, the expected EPS growth rate according to the conventional calculation method on Dec. 29, 2022 was specifically calculated using the calculation formula of (−392−290)/290×100=−235.3%; the expected EPS growth rate according to an embodiment of the present disclosure on Dec. 29, 2022 was specifically calculated using the calculation formula of (−392−290)/ABS (290)×100=−235.3%; the expected EPS growth rate according to the conventional calculation method on Jan. 2, 2023 was specifically calculated using the calculation formula of {105−(−392)}/−392×100=−126.8%; and the expected EPS growth rate according to an embodiment of the present disclosure on Jan. 2, 2023 was specifically calculated using the calculation formula of {105−(−392)}/ABS (−392)×100=126.8%.

In addition, in the calculation of the expected PEG,
the expected PEG according to the conventional calculation method on Dec. 29, 2022 was specifically calculated using the calculation formula of −16.5/{(−392−290)/290×100}−0.070; the expected PEG according to an embodiment of the present disclosure on Dec. 29, 2022 was specifically calculated using the calculation formula of ABS (−16.5)/{(−392−290)/ABS (290)×100}=−0.070; the expected PEG according to the conventional calculation method on Jan. 2, 2023 was specifically calculated using the calculation formula of 58.1/[{105−(−392)}/−392×100]=−0.458; and the expected PEG according to an embodiment of the present disclosure on Jan. 2, 2023 was specifically calculated using the calculation formula of ABS (58.1)/[{105−(−392)}/ABS (−392)×100]=0.458.

In the calculation of the expected PEG, since EPS is calculated on an annual basis, the daily EPS is the same for one year. Accordingly, the expected EPS growth rate is also calculated the same for one year. However, when the year changes and the expected EPS turns from a deficit in the previous year (t) to a surplus one year later (t+1), the growth rate is calculated differently depending on the expected EPS growth rate calculation method.

On Dec. 29, 2022, the expected EPS growth rate is computed to be −235.2% for both the conventional calculation method and the calculation method according to an embodiment of the present disclosure. However, on Jan. 2, 2023, the expected EPS growth rate is −126.8% when calculated using the conventional method, but the expected EPS growth rate is 126.8% when calculated using the method according to an embodiment of the present disclosure. The expected EPS increased from −392 KRW to 105 KRW, but the expected EPS growth rate is a negative number (−126.8%), which is an error, and the correct outcome is a positive number (126.8%).

In addition, the expected PEG is also computed differently. On Dec. 29, 2022, the expected PEG is 0.070 according to the conventional calculation method, and −0.070 when calculated according to the method of an embodiment of the present disclosure. The EPS is expected to decrease from 260 KRW to −392 KRW, but the expected PEG is a positive number (0.070), which is an error, and the correct outcome is a negative number (−0.070).

On Jan. 2, 2023, the expected PEG is −0.458 according to the conventional calculation method, and 0.458 when calculated according to the method of an embodiment of the present disclosure. The EPS is expected to increase from −392 KRW to 105 KRW, but the expected PEG is a negative number (−0.458), which is an error, and the correct outcome is a positive number (0.458).

As such, the conventional expected PEG calculation method produces results that do not match the expected performance of a company and may not be used as a daily investment indicator. The expected PEG calculation method according to an embodiment of the present disclosure produces results that match the expected performance of the company and may be used as a daily investment indicator, which is a significant difference.

(4-3) Comparison of Effect of Conventional Expected PEG Trailing and Expected PEG According to Embodiment of Present Disclosure. By Recent 12 Months.

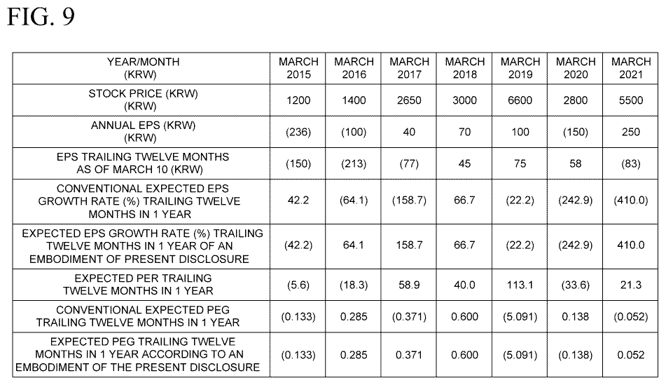

FIG. 9 is an exemplary diagram illustrating an example of a comparison result of the effect of the conventional expected PEG trailing twelve months by year and the expected PEG trailing twelve months according to an embodiment of the present disclosure according to the implementation of the present disclosure.

In [FIG. 9], the stock price and annual EPS are arbitrarily assumed values. The EPS trailing twelve months after 2015 is based on March 10 of each year, the EPS trailing twelve months as of Mar. 10, 2015 is assumed to be −150 KRW, and the expected EPS trailing twelve months as of March 10 of each year after Mar. 10, 2015 is a value calculated using [Mathematical Formula 23] based on the annual EPS of each year arbitrarily assumed. In addition, when the annual EPS in 2022 is assumed to be 300 KRW, the expected EPS trailing twelve months as of Mar. 10, 2021 is calculated as 258 KRW. The expected EPS growth rate (%) trailing twelve months in 1 year after 2021 is calculated based thereon. In addition, the term “conventional expected EPS growth rate (%) trailing twelve months in 1 year” refers to the expected EPS growth rate (%) trailing twelve months in 1 year according to the conventional calculation method, the term “expected EPS growth rate (%) trailing twelve months in 1 year of an embodiment of the present disclosure” refers to the expected EPS growth rate (%) trailing twelve months in 1 year according to an embodiment of the present disclosure, the term “conventional expected PEG trailing twelve months in 1 year” refers to the expected PEG trailing twelve months in 1 year according to the conventional calculation method, and the term “expected PEG trailing twelve months in 1 year according to an embodiment of the present disclosure” refers to the expected PEG trailing twelve months in 1 year according to an embodiment of the present disclosure. The numbers in parentheses indicate negative numbers.

The conventional expected PEG trailing twelve months is calculated using the formula “expected PEG trailing twelve months=expected PER trailing twelve months/expected EPS growth rate trailing twelve months.”

To explain this more specifically,

When the stock price on the calculation date is P, the EPS trialing twelve months of the previous month of a month in which the calculation date falls is EPS ttm, and the expected EPS trailing twelve months in 1 year based on the previous month in which the calculation date falls is EPS ttm+1,
the conventional expected PEG trailing twelve months in 1 year (1YE PEG ttm) may be calculated using the following formula.

$$1 YE PEG ttm = ( P / EPS ttm + 1 ) / \{ ( EPS ttm + 1 - EPS ttm ) / ( EPS ttm ) \times 100 \}$$

The expected PEG trailing twelve months in 1 year (1YE PEG ttm) according to an embodiment of the present disclosure may be calculated by the following formula using [Mathematical Formula 32] above.

$$1 YE PEG ttm = ABS ( P / EPS ttm + 1 ) / \{ ( EPS ttm + 1 - EPS ttm ) / ABS ( EPS ttm ) \times 100 \}$$

Herein, the expected EPS trailing twelve months in 1 year, in other words, EPS ttm+1, is calculated using [Mathematical Formula 23] above, in other words, EPS ttm+1=EPS t+1×{(12−M+1)/12}+EPS t+2× {(M−1)/12}, and the EPS trailing twelve months, in other words, EPS ttm, is historical data, and thus is always available.

As above, the calculation methods of the two expected PEGs are different, and as a result, the expected PEG value, which is the calculation result, also changes. The effect of the conventional expected PEG trailing twelve months and the expected PEG trailing twelve months according to an embodiment of the present disclosure by year is compared and displayed as in [FIG. 9].

In comparison of the effect of the conventional expected PEG trailing twelve months and the expected PEG trailing twelve months according to an embodiment of the present disclosure based on [FIG. 9],

First, according to the conventional expected PEG calculation method, in the 2016 data, when a company's deficit is decreased from a deficit (EPS trailing twelve months of −213 KRW) (Year 2016) to a deficit (EPS trailing twelve months of −77 KRW) in 1 year (Year 2017), the expected EPS growth rate is computed as a negative number (−64.1%), which is incorrectly calculated. In 2017, even though the EPS actually increased compared to 2016, the expected EPS growth rate is negative (−64.1%), which does not reflect reality.

According to the expected PEG calculation method according to an embodiment of the present disclosure, the deficit is reduced, so the expected EPS growth rate is shown as a positive number (64.1%), and the expected PEG value is also calculated as a positive number (0.285), which are all calculated correctly.

Second, according to the conventional expected PEG calculation method, in the 2017 data, a company went from a deficit (EPS trailing twelve months of −77 KRW) (Year 2017) to a surplus (EPS trailing twelve months of 45 KRW) the following year (Year 2018), and the EPS turned from a deficit to a surplus, but the expected EPS growth rate is calculated as a negative number (−158.7%). It is a serious error that the expected EPS growth rate is computed as a negative number when the EPS actually increased (Year 2017). Furthermore, since the expected PER trailing twelve months is positive (58.9), the expected PEG trailing twelve months is calculated as a negative number (−0.371), which causes an error. It is a serious error that the expected PEG is calculated as a negative number (−0.371) when the performance increased and turned into a surplus (EPS trailing twelve months of 45 KRW).

According to the expected PEG calculation method according to an embodiment of the present disclosure, the expected EPS growth rate is computed as a positive number (158.7%) to reflect the actual increase in EPS, so the expected EPS growth rate is correctly calculated, and simultaneously, the expected PEG is also computed as a positive number (0.371). In this respect, there is a very significant difference in the effect of the conventional expected PEG trailing twelve months display and the expected PEG trailing twelve months display according to an embodiment of the present disclosure.

Third, in the 2020 data, the company's annual EPS is −150 KRW, but as of Mar. 10, 2020, the EPS trailing twelve months is 58 KRW. The annual EPS at the end of 2021 turns into a surplus of 250 KRW, but in the process, the expected EPS trailing twelve months as of March 10 is calculated as a deficit (−83 KRW). According to the conventional expected PEG calculation method, the expected EPS growth rate trailing twelve months in 1 year as of Mar. 10, 2020 is correctly calculated as a negative number (−242.9%), but the expected PEG trailing twelve months is computed as a positive number (0.138) despite the EPS trailing twelve months decreasing from a surplus (58 KRW) to a deficit (−83 KRW), resulting in an error.

According to the expected PEG calculation method according to an embodiment of the present disclosure, the expected EPS growth rate is computed as a negative number (−242.9%) to reflect the actual decrease in EPS, so the expected EPS growth rate is correctly calculated, and the expected PEG trailing twelve months is calculated as a negative number (−0.138) and is correctly computed. In this respect, there is a very significant difference in the effect of the conventional expected PEG trailing twelve months display and the expected PEG trailing twelve months display according to an embodiment of the present disclosure.

Fourth, in the 2021 data, the annual EPS is expected to be in a surplus of 250 KRW at the end of 2021, but as of Mar. 10, 2021, the EPS trailing twelve months is negative (−83 KRW), indicating a deficit. In addition, assuming the annual EPS at the end of 2022 is 300 KRW, the expected EPS trailing twelve months in 2022 is calculated as 258 KRW.

The EPS trailing twelve months of a company is expected to turn from a deficit (−83 KRW) in 2021 to a surplus (258 KRW) in 2022. However, according to the conventional calculation method, the expected EPS growth rate trialing twelve months in 1 year is computed as a negative number (−410.0%), resulting in an error, and the expected PEG trailing twelve months is also computed as a negative number (−0.052), resulting in an error that does not properly reflect the performance of turning to a surplus (258 KRW). This causes an issue in which investors may not accurately determine the company value.

According to the PEG calculation method according to an embodiment of the present disclosure, both the expected EPS growth rate trailing twelve months in 1 year in 2021 (410.0%) and the expected PEG value trailing twelve months in 1 year (0.052) are calculated correctly. In this respect, there is a very significant difference in the effect of the conventional expected PEG trailing twelve months display in 1 year and the expected PEG trailing twelve months display in 1 year according to an embodiment of the present disclosure.

As described above, due to this issue with the conventional expected PEG trailing twelve months calculation method, the expected PEG trailing twelve months of a company whose company performance turns from a deficit to a surplus may not be provided. Hence, there is an issue in which investors who use the expected PEG trailing twelve months lose investment opportunities.

According to an embodiment of the present disclosure, since the aforementioned PEG trailing twelve months calculation error may be eliminated and the correct expected PEG value trailing twelve months may be computed. When stock price data and EPS data are available, the expected PEG trailing twelve months by year may be computed at any time to generate yearly time series data and may be utilized for investment. In addition, since stock prices mostly fluctuate daily, it is also possible to compute the expected PEG trailing twelve months on a daily basis. Accordingly, the daily expected PEG trailing twelve months time series data may be generated and utilized for investment.

By implementing as above, an embodiment of the present disclosure eliminates the inconvenience and issues of company information analysis using the conventional expected PEG. The server may receive stock price and EPS data from an entity providing financial market and company-related data, compute various pieces of expected PEG data, and generate time-series expected PEG data.

### MODE FOR CARRYING OUT THE INVENTION

Although the present disclosure has been described above with reference to preferred embodiments thereof with reference to the accompanying drawings, from these descriptions, various modifications are possible without departing from the scope of the present disclosure within the scope encompassed by the claims of the present disclosure.

### INDUSTRIAL APPLICABILITY

First, the present disclosure may be provided for commercial purposes for company information providers such as securities companies, organizations, and general investors.

Second, the present disclosure may broaden the perspective on quantification of market analysis, and thus may be used as a tool for financial education.

What is claimed is:

1. A company information analysis system using expected PEG, the system comprising:
(a) a parameter setting unit that sets parameters necessary for analyzing a company;
(b) a data collection unit that collects stock prices and EPS data necessary for analyzing the expected PEG in a server;
(c) a data arithmetic-operation unit that calculates the expected PEG using [Mathematical Formula 13], [Mathematical Formula 14], [Mathematical Formula 15], [Mathematical Formula 16], [Mathematical Formula 17] and [Mathematical Formula 38] and calculates the expected PEG trailing twelve months using [Mathematical Formula 32], [Mathematical Formula 33] and [Mathematical Formula 34] to specifically process PEG using an arithmetic-operation formula and the data collected in (b) above;
(d) a storage unit that stores data used for analysis and expected PEG calculation results in the server; and
(e) a display unit that displays company information and expected PEG data analyzed and stored in the server on a screen:
$$1 YE PEG = ABS ( P / EPS t + 1 ) / \{ ( EPS t + 1 - EPS t ) / ABS ( EPS t ) \times 100 \} \qquad [ Mathematical Formula 13 ]$$
where,
1YE PEG=Expected PEG in 1 year (1YE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
ABS=Absolute value
$$2 YE PEG = ABS ( P / EPS t + 2 ) / ( EPS t + 2 - EPS t ) / ABS ( EPS t + 1 ) \times 100 \} \qquad [ Mathematical Formula 14 ]$$
where,
2YE PEG=Expected PEG in 2 years (2YE PEG)
P=Stock price on a calculation date
EPS t+1=Expected EPS in 1 year based on the last day of the previous year prior to a year in which the calculation date falls
EPS t+2=Expected EPS in 2 years based on the last day of the previous year prior to a year in which the calculation date falls
ABS=Absolute value
$$3 YE PEG = ABS ( P / EPS t + 3 ) / ( EPS t + 3 - EPS t + 2 ) / ABS ( EPS t + 2 ) \times 100 \} \qquad [ Mathematical Formula 15 ]$$
where,
3YE PEG=Expected PEG in 3 years (3YE PEG)
P=Stock price on a calculation date
EPS t+2=Expected EPS in 2 years based on the last day of the previous year prior to a year in which the calculation date falls
EPS t+3=Expected EPS in 3 years based on the last day of the previous year prior to a year in which the calculation date falls
ABS=Absolute value
$$2 YAE PEG = ABS [ P / \{ ( EPS t + 1 + EPS t + 2 ) / 2 \} ] / [ \{ ( EPS t + 1 + EPS t + 2 ) / 2 - EPS t \} / ABS ( EPS t ) \times 100 ] \qquad [ Mathematical Formula 16 ]$$
where,
2YAE PEG=2-year average expected PEG (2YAE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
EPS t+2=Expected EPS in 2 years based on the last day of the previous year prior to a year in which the calculation date falls
ABS=Absolute value
$$3 YAE PEG = ABS [ P / \{ ( EPS t + 1 + EPS t + 2 + EPS t + 3 ) / 3 \} ] / [ \{ ( EPS t + 1 + EPS t + 2 + EPS t + 3 ) / 3 - EPS t \} / ABS ( EPS t ) \times 100 ] \qquad [ Mathematical Formula 17 ]$$
where,
3YAE PEG=3-year average expected PEG (3YAE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
EPS t+2=Expected EPS in 2 years based on the last day of the previous year prior to a year in which the calculation date falls
EPS t+3=Expected EPS in 3 years based on the last day of the previous year prior to a year in which the calculation date falls
ABS=Absolute value
$$1 YBDE PEG = ABS ( P / EPS t + 1 ) / \{ ( EPS t + 1 - EPS ct ) / ABS ( EPS ct ) \times 100 \} \qquad [ Mathematical Formula 38 ]$$
where,
1YBDE PEG=Expected PEG in 1 year before company performance is announced after the year has changed (1YBDE PEG)
P=Stock price on a calculation date
EPS ct=Expected EPS (consensus, estimated EPS) of the previous year (t) prior to a year in which the calculation date falls
EPS t+1=Expected EPS in 1 year based on the last day of the previous year prior to a year in which the calculation date falls
ABS=Absolute value
$$1 YE PEG ttm = ABS ( P / EPS ttm + 1 ) / \{ ( EPS ttm + 1 - EPS ttm ) / ABS ( EPS ttm ) \times 100 \} \qquad [ Mathematical Formula 32 ]$$
where,
1YE PEG ttm=Expected PEG trailing 12 months in 1 year (1YE PEG ttm)
P=Stock price on a calculation date
EPS ttm=EPS trailing 12 months of the previous month prior to a month in which the calculation date falls
EPS ttm+1=Expected EPS trailing 12 months in 1 year based on the previous month in which the calculation date falls
ABS=Absolute value
$$2 YE PEG ttm = ABS ( P / EPS ttm + 2 ) / \{ ( EPS ttm + 2 - EPS ttm + 1 ) / ABS ( EPS ttm + 1 ) \times 100 \} \qquad [ Mathematical Formula 33 ]$$
where,
2YE PEG ttm=Expected PEG trailing 12 months in 2 years (2YE PEG ttm)
P=Stock price on a calculation date
EPS ttm+1=Expected EPS trailing 12 months in 1 year based on the previous month in which the calculation date falls
EPS ttm+2=Expected EPS trailing 12 months in 2 years based on the previous month in which the calculation date falls
ABS=Absolute value
$$2 YAE PEG ttm = ABS [ P / \{ ( EPS ttm + 1 + EPS ttm + 2 ) / 2 \} ] / [ \{ ( EPS ttm + 1 + EPS ttm + 2 ) / 2 - EPS ttm \} / ABS ( EPS ttm ) \times 100 \qquad [ Mathematical Formula 34 ]$$
where,
2YAE PEG ttm=2-year average expected PEG trailing 12 months (2YAE PEG ttm)
P=Stock price on a calculation date
EPS ttm=EPS trailing 12 months of the previous month prior to a month in which the calculation date falls
EPS ttm+1=Expected EPS trailing 12 months in 1 year based on the previous month in which the calculation date falls
EPS ttm+2=Expected EPS trailing 12 months in 2 years based on the previous month in which the calculation date falls
ABS=Absolute value.

2. A company information analysis method using expected PEG, the method being performed by a server and comprising:
(a) a parameter setting stage that sets parameters necessary for analyzing a company;
(b) a data collection stage that collects stock prices and EPS data necessary for analyzing the expected PEG in the server;
(c) a data arithmetic-operation stage that calculates the expected PEG using [Mathematical Formula 13], [Mathematical Formula 14], [Mathematical Formula 15], [Mathematical Formula 16], [Mathematical Formula 17] and [Mathematical Formula 38] to specifically process PEG using an arithmetic-operation formula and the data collected in (b) above;
(d) a storage stage that stores data used for analysis and expected PEG calculation results in the server; and
(e) a display stage that displays company information and expected PEG data analyzed and stored in the server on a screen:
$$1 YE PEG = ABS ( P / EPS t + 1 ) / \{ ( EPS t + 1 - EPS t ) / ABS ( EPS t ) \times 100 \} \qquad [ Mathematical Formula 13 ]$$
where,
1YE PEG=Expected PEG in 1 year (1YE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
ABS=Absolute value
$$2 YE PEG = ABS ( P / EPS t + 2 ) / \{ ( EPS t + 2 - EPS t + 1 ) / ABS ( EPS t + 1 ) \times 100 \} \qquad [ Mathematical Formula 14 ]$$
where,
P=Stock price on a calculation date
2YE PEG=Expected PEG in 2 years (2YE PEG)
EPS t+1=Expected EPS in 1 year based on the last day of the previous year prior to a year in which the calculation date falls
EPS t+2=Expected EPS in 2 years based on the last day of the previous year prior to a year in which the calculation date falls
ABS=Absolute value
$$3 YE PEG = ABS ( P / EPS t + 3 ) / \{ ( EPS t + 3 - EPS t + 2 ) / ABS ( EPS t + 2 ) \times 100 \} \qquad [ Mathematical Formula 15 ]$$
where,
3YE PEG=Expected PEG in 3 years (3YE PEG)
P=Stock price on a calculation date
EPS t+2=Expected EPS in 2 years based on the last day of the previous year prior to a year in which the calculation date falls
EPS t+3=Expected EPS in 3 years based on the last day of the previous year prior to a year in which the calculation date falls
ABS=Absolute value
$$2 YAE PEG = ABS [ P / \{ ( EPS t + 1 + EPS t + 2 ) / 2 \} ] / [ \{ ( EPS t + 1 + EPS t + 2 ) / 2 - EPS t \} / ABS ( EPS t ) \times 100 ] \qquad [ Mathematical Formula 16 ]$$
where,
2YAE PEG=2-year average expected PEG (2YAE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
EPS t+2=Expected EPS in 2 years based on the last day of the previous year prior to a year in which the calculation date falls
ABS=Absolute value
$$3 YAE PEG = ABS [ P / \{ ( EPS t + 1 + EPS t + 2 + EPS t + 3 ) / 3 \} ] / [ \{ ( EPS t + 1 + EPS t + 2 + EPS t + 3 ) / 3 - EPS t \} / ABS ( EPS t ) \times 100 ] \qquad [ Mathematical Formula 17 ]$$
where,
3YAE PEG=3-year average expected PEG (3YAE PEG)
P=Stock price on a calculation date
EPS t=EPS of the previous year prior to a year in which the calculation date falls
EPS t+1=Expected EPS in 1 year based on the last day of the previous year prior to a year in which the calculation date falls
EPS t+2=Expected EPS in 2 years based on the last day of the previous year prior to a year in which the calculation date falls
EPS t+3=Expected EPS in 3 years based on the last day of the previous year prior to a year in which the calculation date falls
ABS=Absolute value
$$1 YBDE PEG = ABS ( P / EPS t + 1 ) / \{ ( EPS t + 1 - EPS ct ) / ABS ( EPS ct ) \times 100 \} \qquad [ Mathematical Formula 38 ]$$
where,
1YBDE PEG=Expected PEG in 1 year before company performance is announced after the year has changed (1YBDE PEG)
P=Stock price on a calculation date
EPS ct=Expected EPS (consensus, estimated EPS) of the previous year (t) prior to a year in which the calculation date falls
EPS t+1=Expected EPS in 1 year based on the last day of the previous year prior to a year in which the calculation date falls
ABS=Absolute value.

3. A company information analysis method using expected PEG, the method being performed by a server and comprising:
(a) a parameter setting stage that sets parameters necessary for analyzing a company;
(b) a data collection stage that collects stock prices and EPS data necessary for analyzing the expected PEG in the server;
(c) a data arithmetic-operation stage that calculates the expected PEG trailing twelve months using [Mathematical Formula 32], [Mathematical Formula 33] and [Mathematical Formula 34] to specifically process PEG using an arithmetic-operation formula and the data collected in (b) above;
(d) a storage stage that stores data used for analysis and expected PEG calculation results in the server; and
(e) a display stage that displays company information and expected PEG data analyzed and stored in the server on a screen:
$$1 YE PEG ttm = ABS ( P / EPS ttm + 1 ) / \{ ( EPS ttm + 1 - EPS ttm ) / ABS ( EPS ttm ) \times 100 \} \qquad [ Mathematical Formula 32 ]$$
where,
1YE PEG ttm=Expected PEG trailing 12 months in 1 year (1YE PEG ttm)
P=Stock price on a calculation date
EPS ttm=EPS trailing 12 months of the previous month prior to a month in which the calculation date falls
EPS ttm+1=Expected EPS trailing 12 months in 1 year based on the previous month in which the calculation date falls
ABS=Absolute value
$$2 YE PEG ttm = ABS ( P / EPS ttm + 2 ) / \{ ( EPS ttm + 2 - EPS ttm + 1 ) / ABS ( EPS ttm + 1 ) \times 100 \} \qquad [ Mathematical Formula 33 ]$$
where,
2YE PEG ttm=Expected PEG trailing 12 months in 2 years (2YE PEG ttm)
P=Stock price on a calculation date
EPS ttm+1=Expected EPS trailing 12 months in 1 year based on the previous month in which the calculation date falls
EPS ttm+2=Expected EPS trailing 12 months in 2 years based on the previous month in which the calculation date falls
ABS=Absolute value
$$2 YAE PEG ttm = ABS [ P / \{ ( EPS ttm + 1 + EPS ttm + 2 ) / 2 \} ] / [ \{ ( EPS ttm + 1 + EPS ttm + 2 ) / 2 - EPS ttm \} / ABS ( EPS ttm ) \times 100 ] \qquad [ Mathematical Formula 34 ]$$
where,
2YAE PEG ttm=2-year average expected PEG trailing 12 months (2YAE PEG ttm)
P=Stock price on a calculation date
EPS ttm=EPS trailing 12 months of the previous month prior to a month in which the calculation date falls
EPS ttm+1=Expected EPS trailing 12 months in 1 year based on the previous month in which the calculation date falls
EPS ttm+2=Expected EPS trailing 12 months in 2 years based on the previous month in which the calculation date falls
ABS=Absolute value.
